(19) United States
(12) Patent Application Publication
(10) Pub. No.: US 2025/0135358 A1
(43) Pub. Date: May 1, 2025

(54) PROGRAM, INFORMATION PROCESSING DEVICE, METHOD, AND SYSTEM

(71) Applicant: CYGAMES, INC., Tokyo (JP)

(72) Inventors: Kentaro Sekiguchi, Tokyo (JP); Naohiro Harada, Tokyo (JP); Takahito Hoshi, Tokyo (JP)

(73) Assignee: CYGAMES, INC., Tokyo (JP)

(21) Appl. No.: 19/010,505

(22) Filed: Jan. 6, 2025

Related U.S. Application Data
(63) Continuation of application No. PCT/JP2023/027610, filed on Jul. 27, 2023.

(30) Foreign Application Priority Data
Jul. 28, 2022 (JP) 2022-120332

(51) Int. Cl. A63F 13/795; A63F 13/537

(52) U.S. Cl. CPC A63F 13/795; A63F 13/537

(57) ABSTRACT

At least one of the information processing devices functions as a bonus target determination unit for determining that a multiplayer game of a first player is a bonus target when a predetermined parameter of a second player is greater than the predetermined parameter of the first player and a difference between the predetermined parameter of the second player and the predetermined parameter of the first player is equal to or greater than a predetermined value; and at least one of the information processing devices functions as a display determination unit for determining to display a first multiplayer game participation button associated with the multiplayer game, being the bonus target, of the first player in a manner indicating that the multiplayer game of the first player is the bonus target in a display region of a multiplayer game participation button associated with the second player.

### TECHNICAL FIELD

The present invention relates to a program and the like and in particular to a program and the like for a game including a multiplayer game in which a plurality of players participate.

### BACKGROUND ART

In the related art, a game is known including a multiplayer game in which a plurality of players participate via other players participating in the multiplayer game of a player. For example, in a multiplayer game in which a common enemy character is battled against, a character associated with a player and a character associated with another player cooperatively attack and defeat the common enemy character to clear the game.

### CITATION LIST

### Patent Literature

Patent Document 1: JP 2020-120861 A

### SUMMARY OF INVENTION

### Technical Problem

However, when an advanced player experienced in the game is requested to participate in a multiplayer game of a beginner player inexperienced in the game, the advanced player experienced in the game is less likely to be motivated to participate in the multiplayer game of the beginner player as the multiplayer game of the beginner player would provide a lackluster experience for the advanced player experienced in the game. On the other hand, a beginner player may find it difficult to clear the game on their own.

The present invention has been made to solve such a problem, and an object of the present invention is to provide a program, an information processing device, a method, and a system capable of encouraging other players to participate in a multiplayer game and improving the enjoyment of the game as a whole.

### Solution to Problem

A program according to an aspect of the present invention is a program for a game including a multiplayer game in which a plurality of players participate, the program causing a computer to function as:
a multiplayer game executor for executing the multiplayer game on the basis of an operation of a first player;
a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
a participation determiner for determining to allow the second player to participate in the multiplayer game of the first player on the basis of an input with the first multiplayer game participation button performed by the second player; and
a bonus granter for granting a bonus to the second player on the basis of a predetermined condition being satisfied.

The program according to an aspect of the present invention may include at least one of the following configurations [2] to [9]:
[2] the predetermined condition of the bonus granter includes at least the input with the first multiplayer game participation button performed by the second player;
[3] the predetermined condition of the bonus granter includes the number of times the bonus has been granted to the second player per a predetermined amount of time being less than a predetermined number of times;
[4] the predetermined condition of the bonus granter includes a degree of contribution of the second player in the multiplayer game, being the bonus target, of the first player exceeding a predetermined value;
[5] the multiplayer game executor determines, on the basis of the multiplayer game of the first player, an acquired amount of a parameter for increasing the predetermined parameter acquired by the second player, the acquired amount being displayed on a terminal device of the second player;
[6] the multiplayer game executor determines the bonus in accordance with the predetermined parameter of the second player;
[7] the computer is further caused to function as
a participation request receiver for receiving a participation request for the second player different from the first player to participate in the multiplayer game of the first player;
[8] the computer is further caused to function as
a second player determiner for determining the second player with the predetermined parameter thereof being greater than the predetermined parameter of the first player and a difference between the predetermined parameter of the second player and the predetermined parameter of the first player being equal to or greater than a predetermined value, and
a participation request transmission controller for transmitting a participation request for the multiplayer game, being the bonus target, of the first player to the terminal device of the second player, wherein
the second player determiner determines, from among a plurality of players excluding the first player, a predetermined number or more of the second players with the predetermined parameter thereof being greater than the predetermined parameter of the first player and a difference between the predetermined parameter of the second player and the predetermined parameter of the first player being equal to or greater than a predetermined value; or
[9] the multiplayer game is a multi-battle game in which a plurality of players battle against a common enemy character.

An information processing device for a game according to an aspect of the present invention is an information processing device for executing a game including a multiplayer game in which a plurality of players participate, the information processing device comprising:
a multiplayer game executor for executing the multiplayer game on the basis of an operation of a first player;
a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
a participation determiner for determining to allow the second player to participate in the multiplayer game of the first player on the basis of an input with the first multiplayer game participation button performed by the second player; and
a bonus granter for granting a bonus to the second player on the basis of a predetermined condition being satisfied.

A method according to an aspect of the present invention is a method for a game including a multiplayer game in which a plurality of players participate, the method comprising:
a step of executing the multiplayer game on the basis of an operation of a first player;
a step of determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a step of determining to display a first multiplayer game participation button associated with the multiplayer game, being the bonus target, of the first player in a manner indicating that the multiplayer game of the first player is the bonus target in a display region of a multiplayer game participation button associated with the second player;
a step of determining to allow the second player to participate in the multiplayer game of the first player on the basis of an input with the first multiplayer game participation button performed by the second player; and
a step of granting a bonus to the second player on the basis of a predetermined condition being satisfied.

A system according to an aspect of the present invention is a system for executing a game including a multiplayer game in which a plurality of players participate, the system comprising:
a plurality of information processing devices, wherein
at least one of the plurality of information processing devices functions as a multiplayer game executor for executing the multiplayer game on the basis of an operation of a first player;
at least one of the plurality of information processing devices functions as a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
at least one of the plurality of information processing devices functions as a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
at least one of the plurality of information processing devices functions as a participation determiner for determining to allow the second player to participate in the multiplayer game of the first player on the basis of an input with the first multiplayer game participation button performed by the second player; and
at least one of the plurality of information processing devices functions as a bonus granter for granting a bonus to the second player on the basis of a predetermined condition being satisfied.

### Advantageous Effects of Invention

According to the present invention, other players can be encouraged to participate in a multiplayer game and the enjoyment of a game as a whole can be improved.

### BRIEF DESCRIPTION OF DRAWINGS

FIG. 1 is a diagram illustrating an example of the overall configuration of a game system according to one embodiment of the present invention.

FIG. 2 is a block diagram illustrating a hardware configuration of an information processing device.

FIG. 3 is an example of a functional block diagram of the information processing device.

FIG. 4 is an example of a functional block diagram of a game control unit of a server.

FIG. 5 is an example of a multiplayer game screen.

FIG. 6 is an example of a participation request screen.

FIG. 7 is an example of a multiplayer game list screen.

FIG. 8 is another example of a multiplayer game list screen.

FIG. 9 is an example of a game result screen.

FIG. 10 is another example of a game result screen.

FIG. 11 is an example of a sequence diagram of a game system according to one embodiment of the present invention.

### DESCRIPTION OF EMBODIMENTS

A game system according to an embodiment of the present invention will be described with reference to the drawings. In this description, there are cases where descriptions that are more detailed than necessary are omitted for convenience of explanation. For example, there are cases where detailed descriptions of matters that are already well known and repeated descriptions of substantially the same configurations are omitted.

The present game system can be realized by a system in which a plurality of information processing devices are connected via a network, but can also be realized by a plurality of information processing devices that communicate with each other without using a network. First, the embodiment realized by the system connected to a network will be described and then the system realized without using a network will be described.

### Embodiment Realized by System Via Network

### Schematic Configuration

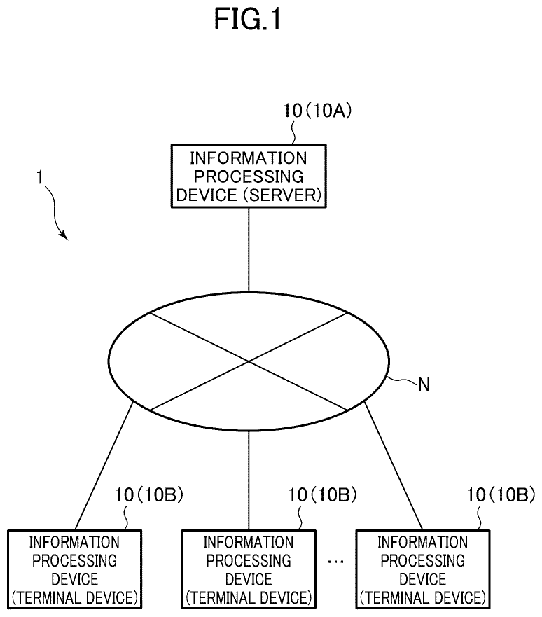

FIG. 1 is a diagram illustrating an example of the overall configuration of the game system according to one embodiment of the present invention. As illustrated in FIG. 1, a game system 1 includes a plurality of information processing devices 10. The information processing devices 10 include a server and a terminal device used by each player. That is, when the information processing device 10 is a server, it is referred to as a server 10A, and when the information processing device 10 is a terminal device, it is referred to as a terminal device 10B. Thus, one aspect of the information processing device 10 is the server 10A and another aspect is the terminal device 10B. The server 10A and the terminal device 10B can have a hardware configuration of the information processing device 10 and are communicably inter-connected with a network N such as the Internet. Note that the game system 1 of this embodiment described herein is a server-client system, the game system 1 can be configured as a system without including the server 10A such as a peer-to-peer (P2P) network.

The server 10A can be constituted of one or more computers that provide a game that can be reproduced on the terminal devices 10B. The terminal device 10B may be a computer such as a smartphone, a tablet computer, a notebook computer, or a desktop computer.

The server 10A stores various programs such as a control program for controlling the progress of an online game and various types of data used in the game. The server 10A transmits and receives data to and from the terminal device 10B periodically or as required to proceed with the game.

In one example, a game application program executable by the terminal device 10B is stored in advance in the terminal device 10B, and each terminal device 10B accepts an input (for example, an operation) related to the game and transmits the input and/or information related to the input to the server 10A. The server 10A executes the game on the basis of the accepted input and/or the information related to the input, transmits an execution result thereof and information necessary for display on the terminal device 10B to the terminal device 10B, and causes an output device 13 of the terminal device 10B to display the information related to the game on a screen. The terminal device 10B according to this embodiment can obtain the game application program by downloading the game application program from the server 10A.

In another example, the server 10A is a web server that provides a game service to the terminal device 10B. The terminal device 10B obtains HTML data for displaying a web page from the server 10A, analyzes the obtained HTML data, and displays the web page. In this case, the server 10A that communicates with the terminal device 10B has the entirety or a portion of functions of a game control unit 25 described below.

### Detailed Configuration

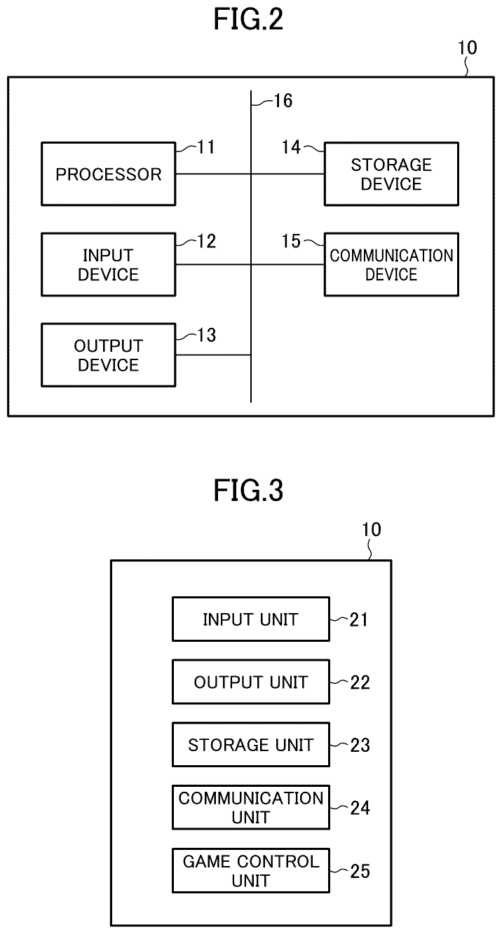

FIG. 2 is a block diagram illustrating the hardware configuration of the information processing device 10. As illustrated in FIG. 2, the information processing device 10 includes a processor 11, an input device 12, the output device 13, a storage device 14, and a communication device 15. The constituent devices 11 to 15 are connected to each other by a bus 16. Interfaces may be interposed as needed between the bus 16 and the individual constituent devices 11 to 15.

The processor 11 controls the operation of the entire information processing device 10 and is an electronic circuit such as a CPU or MPU. The processor 11 executes various types of processing by loading programs and data stored in the storage device 14 and executing the programs. In one example, the processor 11 is constituted of a plurality of processors.

The input device 12 is a user interface for accepting inputs to the information processing device 10 from a user. The input device 12 is, for example, a touch panel, a touchpad, a mouse, a keyboard, or a mouse. When the information processing device 10 includes a touch panel, the touch panel can be assumed to be, for example, a touch screen and function as both the input device 12 and the output device 13. The input device 12 and the output device 13 may be discrete devices that are located at different positions.

The output device 13 presents the user of the information processing device 10, that is a player, with an application screen or the like under the control of the processor 11. Examples of the output device 13 can include a display such as a liquid crystal display, an organic EL display, or a plasma display, or a speaker for emitting sound.

The storage device 14 includes a main memory, a buffer memory, and a storage, and is a storage device provided in a typical smartphone or computer such as a storage device using a volatile memory such as RAM or a nonvolatile flash memory such as eMMC, UFS, or SSD, a magnetic storage device, or the like. The storage device 14 can also include an external memory. The storage device 14 stores, for example, a game application. The game application includes a game program for executing the game and various types of data referenced when executing the game program. The game program is started up in response to a user operation on the information processing device 10 and executed on an operating system (OS) installed in advance on the information processing device 10.

In one example, the storage device 14 includes a main storage device and an auxiliary storage device. The main storage device is a volatile storage medium capable of high-speed reading and writing and is used as a storage area and a work area when the processor 11 processes information. The auxiliary storage device stores various types of programs and data used by the programs when the programs are executed. The auxiliary storage device is, for example, an SSD or a hard disk device, but may be any type of nonvolatile storage or nonvolatile memory that can store information, and may be of the removable type. For example, the auxiliary storage device stores the operating system (OS), middleware, application programs, various types of data that may be referenced when these programs are executed, etc.

The communication device 15 exchanges data with another computer such as a server and the other information processing devices 10 via the network N. For example, the communication device 15 performs wireless communication, such as mobile communication or wireless LAN, to connect to the network N. In one example, the information processing device 10 downloads a program from a server via the communication device 15 and stores the program in the storage device 14. The communication device 15 may perform wired communication by using, for example, an Ethernet (registered trade name) cable. When data is not transmitted to and received from another computer, the information processing device 10 need not include the communication device 15.

FIG. 3 is an example of a functional block diagram of the information processing device 10. The information processing device 10 includes an input unit 21, an output unit 22, a storage unit 23, a communication unit 24, and the game control unit 25. In this embodiment, these functions are realized as a result of the processor 11 executing programs. For example, the program to be executed may be a game program stored in the storage device 14 or received via the communication device 15. Since various types of functions are realized by loading a program, as described above, a portion or the entirety of one part (function) may be provided in another part. The various types of functions are realized as methods by executing a program. These functions may be realized by means of hardware by configuring electronic circuits or the like for realizing the individual functions in part or in their entirety.

The input unit 21 is configured to use the input device 12 to accept inputs to the information processing device 10 from the user. The output unit 22 is configured to use the output device 13 to present information related to the game for presentation to the user of the information processing device 10. The storage unit 23 is configured to use the storage device 14 to store the various types of information related to the game and the programs. The communication unit 24 is configured to use the communication device 15 to function as an interface for transmitting and receiving information to and from the other information processing devices 10. The communication unit 24 transmits input information from the user accepted by the input unit 21 to the other information processing devices 10 via the network N. The communication unit 24 receives information from the other information processing devices 10 and transfers the information to each unit.

The game control unit 25 performs basic control when executing the game according to this embodiment. The game control unit 25 includes the processor 11, executes the game, and causes the output device 13 to display a screen related to the game. The game control unit 25 executing the game can include: obtaining the information required for execution from the storage device 14; obtaining player operation information via the input device 12, the communication device 15, and/or the network N; executing game information processing on the basis of the required information; and generating and/or obtaining the information required for causing the output device 13 to display a screen on the basis of the information processing.

Next, the game and the game control unit 25 of the server 10A according to this embodiment will be described in detail.

### Game

The game according to this embodiment includes a multiplayer game. The multiplayer game is a game in which a plurality of players participate together after a player requests other players to participate. The multiplayer game can be included in a player vs player game, a racing game, a rhythm game, a fighting game, a life simulation game, a quiz game, and other games in which a plurality of players participate, and can be a game in which players cooperate with each other. The multiplayer game according to this embodiment is a multi-battle game. The multi-battle game is a game in which a plurality of players (a plurality of pieces of game content each associated with a player or another player) battle against a common enemy character. The game content is electronic data used in a game, such as a character, a weapon, an item, and an equipment item such as a card. The game content according to this embodiment may be a character. In one example, in a multi-battle game, when a character associated with the player or the other player(s) attacks a common enemy character and a health parameter (HP) of the enemy character becomes 0, the player and the other player(s) win.

In the following description, the players participating in a multiplayer game are referred to as a player and another player or as a first player and a second player in order to distinguish the different players from each other. The other player and the second player may refer to one or more players different from the player and the first player.

### Game Control Unit of Server

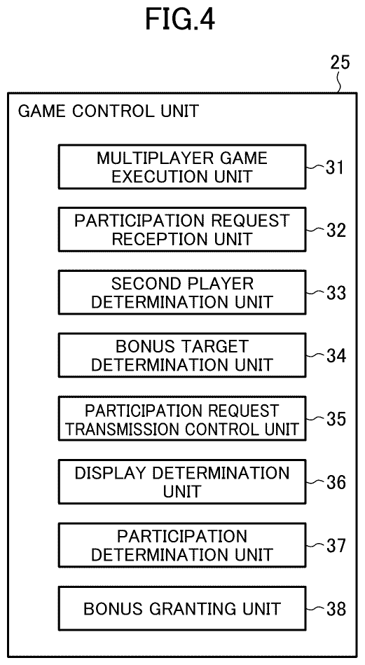

FIG. 4 is an example of a functional block diagram of the game control unit of the server. The game control unit 25 of the server 10A includes a multiplayer game execution unit 31, a participation request reception unit 32, a second player determination unit 33, a bonus target determination unit 34, a participation request transmission control unit 35, a display determination unit 36, a participation determination unit 37, and a bonus granting unit 38.

The multiplayer game execution unit 31 executes the multiplayer game on the basis of an operation by the first player. Furthermore, when the second player different from the first player participates in the multiplayer game of the first player, the multiplayer game execution unit 31 can execute the multiplayer game on the basis of an operation by the second player. The multiplayer game execution unit 31 accepts an operation input from the first player and/or the second player via the input device 12 of the terminal device 10B of the first player and/or the second player. Then, the multiplayer game execution unit 31 executes game processing of the multiplayer game on the basis of the accepted operation input. In one example, the multiplayer game execution unit 31 accepts an operation input from the terminal device 10B of the first player and the second player for the character of the first player and the character of the second player to attack the enemy character; calculates the amount of damage to the enemy character on the basis of the operation input and the parameters associated with the character of the first player, the character of the second player, and the enemy character; and decreases the HP of the enemy character on the basis of the amount of damage.

In another example, on the basis of the multiplayer game of the first player, the multiplayer game execution unit 31 determines an acquired amount of the parameter acquired by the second player to be displayed on the terminal device 10B of the second player. This parameter is a parameter for increasing a predetermined parameter (rank as described below) of the second player and indicates rank points as described below, for example. The multiplayer game execution unit 31 can set the acquired amount to α % of the rank points required for the second player to level up to the next rank (in other words, one rank higher). For example, a can be a real number satisfying 0<α≤100, but is not limited thereto. The acquired amount can be one of bonuses described below.

In another example, the multiplayer game execution unit 31 can determine a bonus on the basis of a predetermined parameter (for example, rank) of the second player. In one example, the multiplayer game execution unit 31 increases the parameter (rank points) for increasing a predetermined parameter (rank) of the second player more when the predetermined parameter is greater. In another example, the multiplayer game execution unit 31 changes the value of a in accordance with the rank when α % of the rank points required for the second player to level up to the next rank is set as a bonus. In another example, the multiplayer game execution unit 31 may determine the acquired amount of a parameter for increasing the character level of the player as a bonus. The parameter may be, for example, experience points (EXP).

The multiplayer game execution unit 31 generates presentation screen information by executing the game processing and transmits the presentation screen information to the terminal device 10B of the first player and/or the second player via the communication device 15. The presentation screen information may be information included in various game screens to be output by the output device 13 of the terminal device 10B of the first player and the second player.

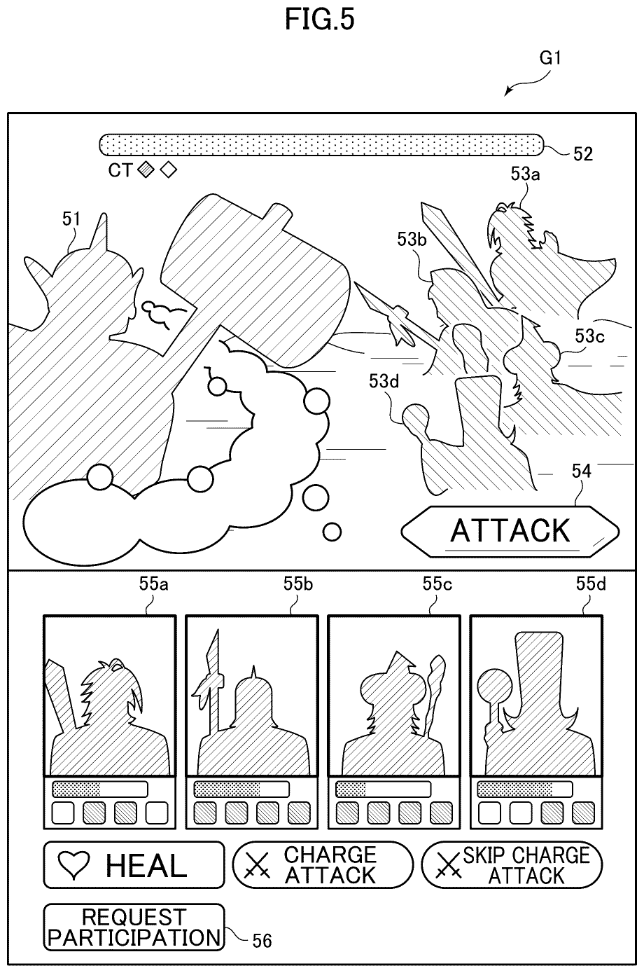

FIG. 5 is an example of a multiplayer game screen. A multiplayer game screen G1 illustrated in FIG. 5 is a battle screen displayed on the output device 13 (display device) of the terminal device 10B of the first player on the basis of the presentation screen information generated by the multiplayer game execution unit 31. The battle screen includes an enemy character image 51, remaining HP (%) 52 of the enemy character, player character images 53a to 53d, an attack button 54, player character designation buttons 55a to 55d, and a participation request button 56.

The enemy character image 51 is an image of an enemy character in the multi-battle game started by the first player. The player character images 53a to 53d are images of player characters associated with the first player. The player characters are characters associated with the first player and selected by the first player for the battle. In other words, the battle screen illustrates a state in which the first player is battling against the enemy character using a plurality of player characters and the second player has not yet participated in the battle game. The attack button 54 is a button for attacking the enemy character via an operation input (for example, touch or tap) from the first player. The player character designation buttons 55a to 55d correspond to the player characters of the player character images 53a to 53d, respectively, and are buttons for executing an ability specific to the corresponding player character. The participation request button 56 is a button for requesting the second player to participate in the multiplayer game (here, the multi-battle game) of the first player. Here, when the operation input of the participation request button 56 is performed by the first player, a participation request screen is displayed on the output device 13 (display device) of the terminal device 10B of the first player.

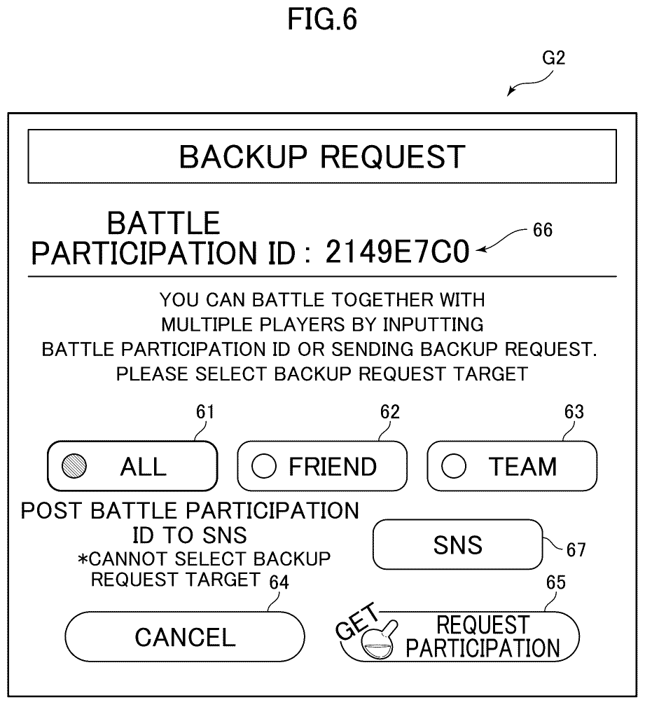

FIG. 6 is an example of a participation request screen. In the example illustrated in FIG. 6, a participation request screen G2 includes an “all” button 61, a “friend” button 62, and a “team” button 63 for selecting the target players for the participation request, a cancel button 64, a participation request button 65, a battle participation ID 66, and an SNS button 67. The “all” button 61 is a button for setting all players other than the first player as participation request target candidates. When the “all” button 61 is selected by a player, a participation request can be made to a predetermined number of players randomly selected from all players other than the first player. The “friend” button 62 is a button for selecting a friend as the participation request target. A friend is one or more other players associated with the first player. The “team” button 63 is a button for selecting a member of a team as a participation request target. A team is a team to which the first player belongs and a plurality of players are associated with the team. At least one of the buttons 61 to 63 can be selected, and any two or three of the buttons 61 to 63 may be selected.

The cancel button 64 is a button for returning to the previous screen, that is, the multiplayer game screen G1. The participation request button 65 is a button for transmitting a participation request for the multiplayer game of the first player to the participation request target selected by the first player. The participation request button 65 is enabled when at least one of the buttons 61 to 63 is selected. The battle participation ID 66 is the ID of the multiplayer game of the first player. The SNS button 67 is a button for posting the battle participation ID to a social networking service (SNS). As described below, the other player(s) can participate in the multiplayer game of the first player by inputting the battle participation ID 66 into a battle participation ID input field 81.

When the operation input of the participation request button 65 is performed by the first player, a participation request is transmitted from the terminal device 10B of the first player to the server 10A. The participation request may include a signal, data, or information indicating the player ID of the first player, the battle participation ID 66, and the participation request for the multiplayer game of the first player. This participation request may include information of the type of participation request target player selected by the first player (for example, “all”, “friend”, or “team”).

The participation request reception unit 32 receives a participation request for the second player to participate in the multiplayer game of the first player. The participation request may include a signal, data, or information indicating the player ID of the first player, the battle participation ID 66, and the participation request for the multiplayer game of the first player, which are transmitted from the terminal device 10B of the first player to the server 10A. This participation request may include data or information of the type of participation request target player selected by the first player (for example, “all”, “friend”, or “team”).

The second player determination unit 33 determines a second player with a predetermined parameter greater than the predetermined parameter of the first player and a difference from the predetermined parameter of the first player being equal to or greater than a predetermined value. The predetermined parameter is a parameter associated with each player and is, for example, a rank. The rank indicates the level of proficiency in the game. The rank is, for example, a numerical value and can be increased by acquiring rank points. A rank point is a parameter that can be acquired according to the result of a multiplayer game and is a parameter for increasing the rank. Here, the predetermined value serving as the threshold may be, for example, 50, but is not limited thereto. The second player determination unit 33 can specify the second player from among a plurality of second players preregistered in the server 10A. The second player determination unit 33 can specify the second player from among the participation request target players on the basis of the type of participation request target players included in the participation request received from the terminal device 10B of the first player.

The second player determination unit 33 can determine a predetermined number or more of second players, from among the plurality of players excluding the first player, with the predetermined parameter greater than the predetermined parameter of the first player and a difference from the predetermined parameter of the first player being equal to or greater than a predetermined value. The predetermined number may be any natural number and may be set as appropriate. In one example, when only the “all” button 61 is selected on the participation request screen G2 and a participation request is sent, the second player determination unit 33 can determine the predetermined number or more of players satisfying the condition of “the predetermined parameter of the second player is greater than the predetermined parameter of the first player and the difference between the predetermined parameter of the second player and the predetermined parameter of the first player is equal to or greater than a predetermined value” as the second players from among randomly selected players. When the number of second players among the extracted players is less than the predetermined number, the second player determination unit 33 may determine the second player from among additional randomly selected players until the predetermined number or more of second players are determined. For a predetermined multiplayer game, the second player determination unit 33 can determine a player with a predetermined parameter (for example, rank) equal to or greater than the predetermined value as the second player. Thus, the predetermined parameter being equal to or greater than the predetermined value can be set as the condition to participate in the multiplayer game.

When the predetermined parameter of the second player is greater than the predetermined parameter of the first player and the difference between the predetermined parameter of the second player and the predetermined parameter of the first player is equal to or greater than the predetermined value, the bonus target determination unit 34 determines that the multiplayer game of the first player is a bonus target. The condition of “the predetermined parameter of the second player being greater than the predetermined parameter of the first player and the difference between the predetermined parameter of the second player and the predetermined parameter of the first player being equal to or greater than the predetermined value” is the same condition used by the second player determination unit 33 to specify the second player. The bonus target is a multiplayer game in which a bonus can be granted to the second player when the second player participates in the multiplayer game of the first player corresponding to the target. Since the multiplayer game of the first player is a bonus target, it can be said that the first player is relatively a beginner compared to the second player.

The participation request transmission control unit 35 transmits a participation request for the multiplayer game, being a bonus target, of the first player to the terminal device 10B of the second player. Specifically, the participation request transmission control unit 35 causes the communication device 15 to transmit the participation request to the terminal device 10B of the one or more second players specified by the second player determination unit 33.

The display determination unit 36 determines to display a first multiplayer game participation button associated with the multiplayer game, being a bonus target, of the first player in a manner indicating that the multiplayer game of the first player is a bonus target in a display region of the multiplayer game participation button associated with the second player. The display region of the multiplayer game participation button associated with the second player is a region displayed on a multiplayer game list screen displayed on the output device 13 of the terminal device 10B of the second player to whom the participation request has been transmitted. In one example, the display region of the multiplayer game participation button associated with the second player is a selection tab content display region 73 described below.

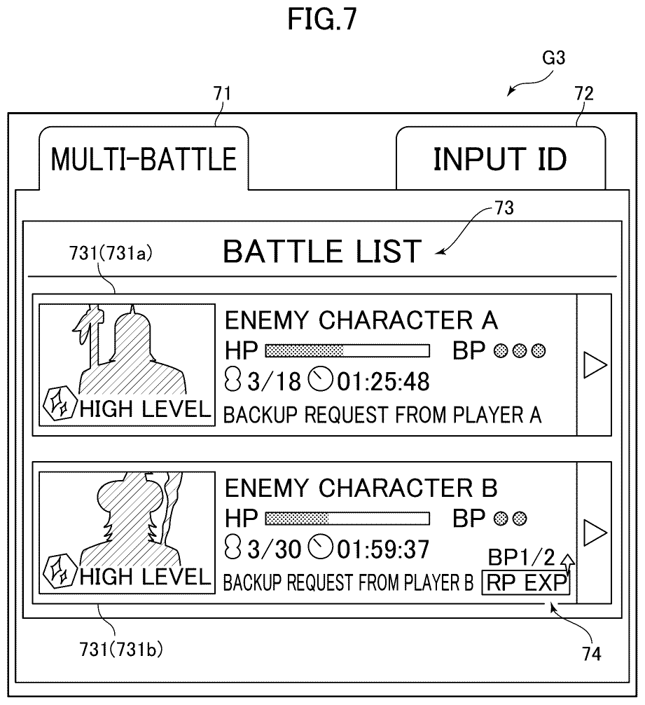

FIG. 7 is an example of a multiplayer game list screen. In the example illustrated in FIG. 7, a multiplayer game list screen G3 includes a multi-battle tab 71, an ID input tab 72, and the selection tab content display region 73. The multi-battle tab 71 is a tab for displaying a display list of multi-battle games. The ID input tab 72 is a tab for displaying a battle participation ID input field for inputting a battle participation ID associated with the multi-battle game of another player. The selection tab content display region 73 displays a display list of multi-battle games or a battle participation ID input field.

When the multi-battle tab 71 is selected, a display list of multi-battles is displayed in the selection tab content display region 73. In the example illustrated in FIG. 7, the multi-battle tab 71 is selected, and a plurality of multiplayer game participation buttons 731 (731a, 731b) are displayed in a selectable manner in the selection tab content display region 73. When any one of the multiplayer game participation buttons 731 is selected, the second player can participate in the multi-battle game associated with the selected multiplayer game participation button 731. Each multiplayer game participation button 731 can display information including an image, a name, a level, and a HP bar indicating the remaining HP of the enemy character of the multiplayer game corresponding to the button 731, the number of points (BP) consumed to participate in the multi-battle game, the current number of participants in the multi-battle game, the remaining time of the multi-battle game, and the participation request player name. The multiplayer game participation button 731a is the normal multiplayer game participation button 731, for example, and is a button for participating in a multiplayer game for which a participation request is performed by the selection of one of the “all” button 61, the “friend” button 62, and the “team” button 63.

The multiplayer game participation button 731b is a button for participating in a multiplayer game that is a bonus target. Unlike the button 731a, the multiplayer game participation button 731b is displayed in a manner indicating that the multiplayer game of the first player is a bonus target. For example, the multiplayer game participation button 731b can be entirely or partially displayed in a color different from that of the button 731a. In addition, the multiplayer game participation button 731b can include a display of an icon 74 indicating that the multiplayer game of the first player is a bonus target. The icon 74 may include information indicating the content of the bonus. In the example illustrated in FIG. 7, the icon 74 displays that rank points (RP) and experience points (EXP) can be gained as a bonus and that the consumed points (BP) are reduced to half (½). The multiplayer game participation button 731b is also referred to as a “first multiplayer game participation button (731b)”. In addition, the first multiplayer game participation button 731b only needs to be distinguishable for the player and can take various forms to differentiate the first multiplayer game participation button 731b from the multiplayer game participation button 731a, which is not a bonus target, including having different text, color, size of the display region, and/or display image. Experience points (EXP) is a parameter for increasing the level of the character associated with the player.

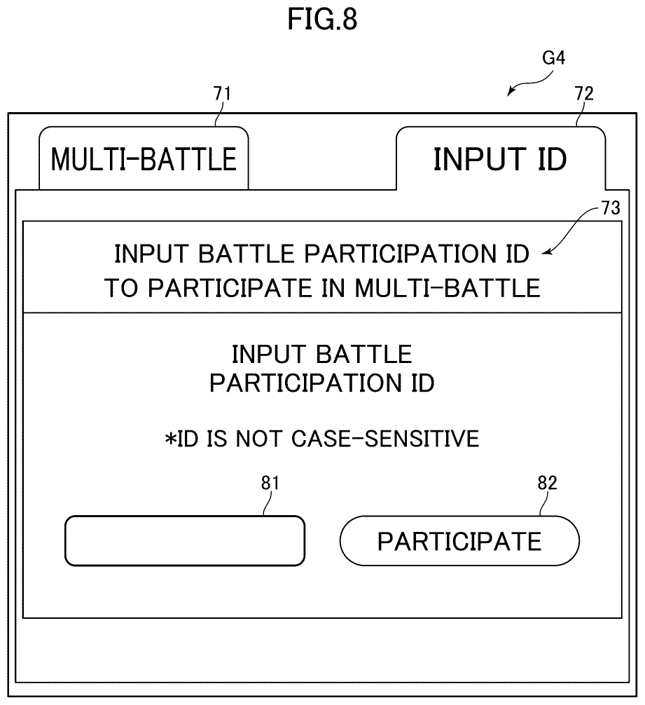

When the ID input tab 72 is selected, the battle participation ID input field is displayed in the selection tab content display region 73. In the example illustrated in FIG. 8, the ID input tab 72 is selected, and the battle participation ID input field 81 and a participation button 82 are displayed in the selection tab content display region 73. The battle participation ID input field 81 is a field for inputting a battle participation ID of another player obtained by the second player via SNS or the like. The participation button 82 is a button for participating in the multiplayer game corresponding to the battle participation ID input in the battle participation ID input field 81. By selecting the participation button 82, the second player can participate in the multiplayer game corresponding to the input battle participation ID.

The participation determination unit 37 determines to allow the second player to participate in the multiplayer game of the first player on the basis of the input with the first multiplayer game participation button 731b performed by the second player. Specifically, the participation determination unit 37 receives a participation request from the terminal device 10B of the second player via selection of the first multiplayer game participation button 731b and specifies the multiplayer game to be participated in and the second player, the participating player, from the ID of the multiplayer game of the first player and the player ID of the second player included in the participation request. Then, the participation determination unit 37 determines to allow the specified second player to participate in the multiplayer game of the first player, the multiplayer game being a game for which a participation request is performed. This makes it possible to specify the terminal device 10B of the second player as the transmission destination of the presentation screen information (for example, the multiplayer game screen G1) generated by the multiplayer game execution unit 31.

The bonus granting unit 38 grants a bonus to the second player on the basis of a predetermined condition being satisfied. The predetermined condition can include at least one of the following (1) to (6) or a combination of two or more of the following (1) to (6)
(1) An input with the first multiplayer game participation button 731b performed by the second player;
(2) The number of times a bonus has been granted to the second player per a predetermined amount of time being less than a predetermined number of times;
(3) The degree of contribution by the second player to the multiplayer game, being a bonus target, of the first player exceeding a predetermined value;
(4) Satisfying (1) and winning the multiplayer game of the first player;
(5) Satisfying (1) and the multiplayer game of the first player ending;
(6) The predetermined parameter of the second player being greater than the predetermined parameter of the first player and the difference between the predetermined parameter of the second player and the predetermined parameter of the first player being equal to or greater than the predetermined value.

In addition, the predetermined condition need not include (2) the limitation on the number of times a bonus is granted and (3). The bonus granting unit 38 can count the number of times a bonus is granted for (2) and store the number in the storage device 14. When the bonus is granted, the bonus granting unit 38 increments the count number by one and stores the count number in the storage device 14. The degree of contribution of (3) is a parameter based on, for example, the action of the second player during the battle and the amount of damage inflicted on the enemy character. The degree of contribution can be calculated by the multiplayer game execution unit 31. Winning the multiplayer game of the first player and the multiplayer game of the first player ending correspond to, for example, getting the HP of the enemy character to 0. According to (6), even when the first player has not sent a participation request for the multiplayer game to other players or when there is no input operation for (1), the bonus granting unit 38 can grant a bonus. The bonus can include game content such as rank points, experience points, and/or items. This game content may be exclusive game content that can be obtained only in the multiplayer game of the first player participated in via input of the first multiplayer game participation button 731b.

The bonus can be referred to as a reward. The bonus can be an additional reward that is added to a reward when the multiplayer game of the first player is not a bonus target. Thus, the second player can acquire the normal reward and the additional reward in the bonus target multiplayer game. Typical rewards can include game content such as rank points, experience points, and/or items.

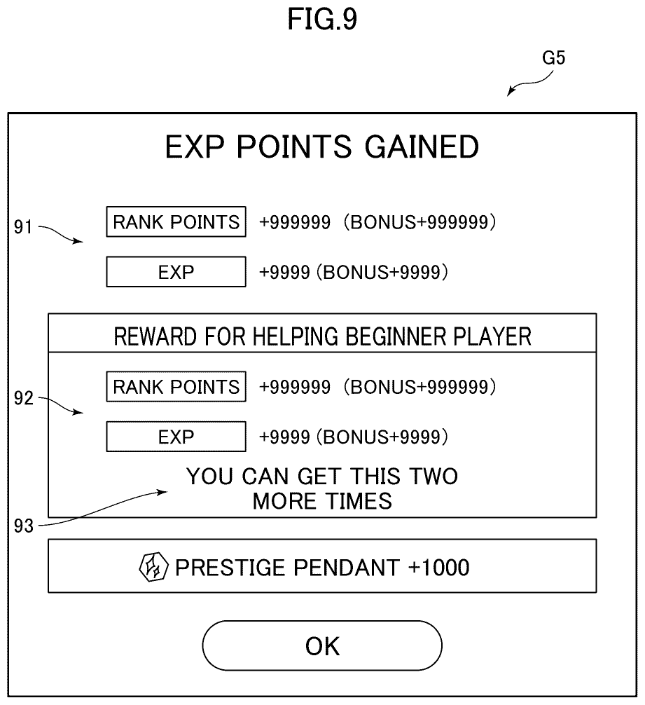

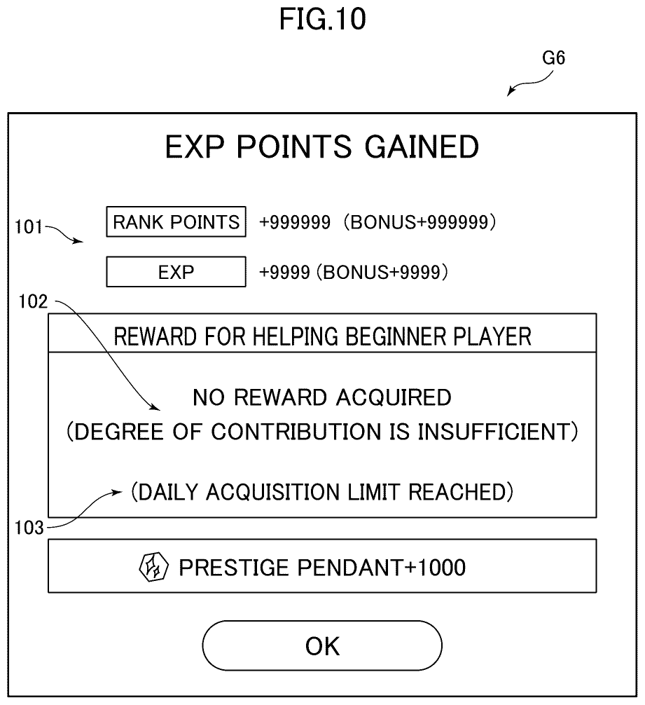

FIG. 9 is an example of a game result screen, and FIG. 10 is another example of a game result screen. Game result screens G5 and G6 of FIGS. 9 and 10 are screens displayed on the output device 13 of the terminal device 10B of the second player on the basis of the presentation screen information generated by the multiplayer game execution unit 31 when a bonus is granted.

The game result screens G5 and G6 include normal reward display regions 91 and 101, additional reward display regions 92 and 102, and grant bonus remaining number display regions 93 and 103.

The normal reward display regions 91 and 101 display normal rewards acquired on the basis of in-game actions of the first player and the second player regardless of whether or not the multiplayer game is a bonus target. In the examples illustrated in FIGS. 9 and 10, the normal reward is rank points and experience points (EXP).

The additional reward display regions 92 and 102 display additional rewards that are a bonus. In the example illustrated in FIG. 9, the additional reward is rank points and experience points (EXP). In the example illustrated in FIG. 10, the additional reward display region 102 displays “No reward acquired (insufficient degree of contribution)”. This indicates that the degree of contribution of the second player to the multiplayer game was less than the predetermined value. In addition, in the additional reward display regions 92 and 102, in a case where the number of times a bonus is granted per day has already reached the maximum, “no additional reward” can be displayed. For example, the addition amount of the rank points and experience points can be displayed as zero.

The grant bonus remaining number display regions 93 and 103 display the remaining number of times a bonus can be granted. In the example illustrated in FIG. 9, the grant bonus remaining number display region 93 displays “You can get this two more times”, which indicates that you can participate in a multiplayer game of other player at least two more times. In the example illustrated in FIG. 10, the grant bonus remaining number display region 103 displays “daily acquisition limit reached”, which indicates that the upper limit of bonus grants per day has been reached with the current bonus grant.

### Operations

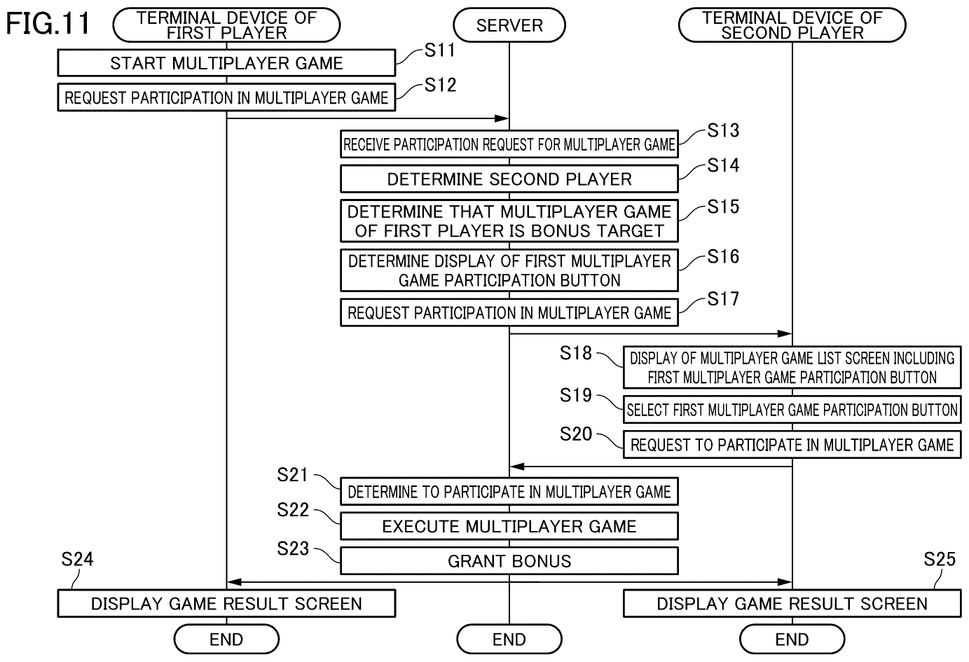

FIG. 11 is an example of a sequence diagram of the game system 1 according to one embodiment of the present invention. First, a multiplayer game is started on the terminal device 10B of the first player (S11). Specifically, the terminal device 10B of the first player transmits the operation input of the first player via the input device 12 to the server 10A, and the multiplayer game execution unit 31 of the server 10A starts the multiplayer game on the basis of the operation input. The server 10A transmits the presentation screen information generated by the multiplayer game execution unit 31 to the terminal device 10B of the first player, and the terminal device 10B causes the output device 13 to display the multiplayer game screen G1 on the basis of the information.

The terminal device 10B of the first player transmits, to the server 10A, a participation request for the multiplayer game by a player other than the first player on the basis of the operation input of the first player via the input device 12 (S12). Specifically, when the participation request button 56 of the multiplayer game screen G1 is touched, the terminal device 10B of the first player causes the output device 13 to display the participation request screen G2, accepts the selection of the “all” button 61 by the first player, and, when the participation request button 65 is touched by the first player, transmits a participation request for the multiplayer game of the first player to the server 10A. However, the terminal device 10B of the first player may transmit a participation request for the multiplayer game of the first player to the server 10A when the condition is satisfied even if the “friend” button 62 or the “team” button 63 is selected. Here, it is assumed that the “all” button 61 is selected.

The server 10A receives the participation request from the terminal device 10B of the first player via the participation request reception unit 32 (S13). The participation request includes the player ID of the first player, data indicating the participation request, and data of the type of player participating (in this example, “all”).

The server 10A determines the second player via the second player determination unit 33 (S14). Specifically, the second player determination unit 33 reads the rank corresponding to the player ID of the first player from the storage device 14 of the server 10A and identifies the rank of the first player. The second player determination unit 33 selects a plurality of players by lottery from all players other than the first player and determines a player, from among the plurality of players, with a rank higher than the rank of the first player and with a difference from the rank of the first player that is equal to or greater than a predetermined value as the second player. The lottery of the plurality of players and the determination of the second player may be repeated until the number of the second players reaches the predetermined value or greater. Note that in this example, one or more of the plurality of players is the second player. However, the second player determination unit 33 may select, from the other player(s), players with a rank higher than the rank of the first player and with a difference from the rank of the first player that is equal to or greater than a predetermined value and from these players may determine a predetermined number or more of players as the second players.

Since the rank of the second player is higher than the rank of the first player and the difference between the rank of the second player and the rank of the first player is equal to or greater than the predetermined value, the server 10A determines that the multiplayer game of the first player is a bonus target using the bonus target determination unit 34 (S15). Then, the server 10A uses the display determination unit 36 to determine to display a first multiplayer game participation button associated with the multiplayer game, being a bonus target, of the first player in a manner indicating that the multiplayer game of the first player is a bonus target in a display region of the multiplayer game participation button associated with the second player (S16). The server 10A uses the participation request transmission control unit 35 to transmit a participation request for the multiplayer game, being a bonus target, of the first player to the terminal device 10B of the second player (S17).

The terminal device 10B of the second player who has received the participation request causes the output device 13 to display the multiplayer game list screen G3 (S18). When the multi-battle tab 71 is selected, the screen G3 can include a display of the first multiplayer game participation button 731b. The first multiplayer game participation button 731b is displayed in a special manner, unlike the multiplayer game participation button 731a for participating in a normal multiplayer game.

The terminal device 10B of the second player can limit the number of the first multiplayer game participation buttons 731b to be displayed. For example, the terminal device 10B of the second player can set the number of first multiplayer game participation buttons 731b that can be displayed to a predetermined number (for example, 2). The predetermined number may be any natural number and can be set as appropriate. When a number of participation requests exceeding the predetermined number are received from one or more first players via the server 10A, the terminal device 10B of the second player may determine the first multiplayer game participation button 731b to be displayed according to the order of arrival, lottery, or bonus. In addition, when the number of multiplayer games of the first player that can be participated in per day or the number of times a bonus can be granted per day is limited to a predetermined number, the terminal device 10B of the second player may display a number of the first multiplayer game participation buttons 731b within the range of the limit number. When the number of multiplayer games of the first player that can be participated in per day or the number of times a bonus can be granted per day is three, up to three first multiplayer game participation buttons 731b can be displayed. When the second player has already participated in two bonus target multiplayer games or has already been granted a bonus twice in one day, the remaining one first multiplayer game participation button 731b may be displayed. The terminal device 10B of the second player need not display the first multiplayer game participation button 731b when the number of times a bonus is granted to the second player in a predetermined amount of time (for example, per day) is equal to or greater than a predetermined number of times. When a participation request for a multiplayer game that is not a bonus target and a participation request for a multiplayer game that is a bonus target received via the “all” button 61, the “friend” button 62, or the “team” button 63 have the same multiplayer game ID, in other words, when two or more participation requests are for the same multiplayer game, the multiplayer game participation button 731 for the multiplayer game (not bonus target) for which a participation request is performed via one of the buttons 61 to 63 may be prioritized and the multiplayer game participation button 731a that is not a bonus target may be displayed by the terminal device 10B of the second player. However, the terminal device 10B of the second player may display the first multiplayer game participation button 731b that is a bonus target.

The terminal device 10B of the second player accepts the selection of the first multiplayer game participation button 731b by the second player (S19) and transmits a participation request for the multiplayer game corresponding to the selected first multiplayer game participation button 731b to the server 10A (S20). This participation request can include the ID of the multiplayer game of the first player, the player ID of the second player, and data and information indicating the request to participate.

The server 10A receives the participation request from the terminal device 10B of the second player, and the participation determination unit 37 determines to allow the second player specified in the participation request to participate in the multiplayer game of the first player (S21).

The server 10A exchanges operation input, information, and/or data with the terminal devices 10B of the first player and the second player and executes processing of the multiplayer game via the multiplayer game execution unit 31 (S22). Specifically, the server 10A generates presentation screen information via the multiplayer game execution unit 31 and transmits the presentation screen information to the terminal devices 10B of the first player and the second player. Each terminal device 10B displays a multiplayer game screen based on the presentation screen information, accepts an operation input (for example, a touch on the attack button 54) from each player in the multiplayer game, and transmits the operation input to the server 10A. The server 10A uses the multiplayer game execution unit 31 to execute the game processing on the basis of the accepted input. The multiplayer game execution unit 31 can calculate the degree of contribution of the second player in the multiplayer game on the basis of the operation input of the second player. The multiplayer game execution unit 31 can execute the game processing until the HP of the enemy character becomes 0 or until the HP of the first player and the second player becomes 0. In one example, the multiplayer game execution unit 31 determines the acquired amount for the rank parameter to be acquired by the second player.

When the HP of the enemy character or the first player and the second player becomes 0, the bonus granting unit 38 grants a bonus to the second player on the basis of the predetermined condition being satisfied (S23). The multiplayer game execution unit 31 generates presentation screen information including bonus information to be displayed on the game result screen and transmits the information to each terminal device 10B. The terminal device 10B of the first player and the second player display the game result screen on the basis of the received presentation screen information (S24, S25). In one example, the terminal device 10B of the second player displays the game result screen G5 or the game result screen G6. Accordingly, the second player can know the bonus information.

### Actions and Effects

(1) A system according to this embodiment is a system for a game including a multiplayer game in which a plurality of players participate via a player requesting other players to participate. The system 1 includes the plurality of information processing devices 10. At least one of the information processing devices 10 functions as the multiplayer game execution unit 31 for executing the multiplayer game on the basis of an operation of a first player. At least one of the information processing devices 10 functions as the participation request reception unit 32 for receiving a participation request for a second player different from the first player to participate in a multiplayer game of the first player. At least one of the information processing devices 10 functions as the bonus target determination unit 34 for determining that the multiplayer game of the first player is the bonus target when a predetermined parameter of the second player is greater than the predetermined parameter of the first player and a difference between the predetermined parameter of the second player and the predetermined parameter of the first player is equal to or greater than a predetermined value. At least one of the information processing devices 10 functions as the display determination unit 36 for determining to display a first multiplayer game participation button associated with the multiplayer game, being the bonus target, of the first player in a manner indicating that the multiplayer game of the first player is the bonus target in a display region of a multiplayer game participation button associated with the second player. At least one of the information processing devices 10 functions as the participation determination unit 37 for determining to allow the second player to participate in the multiplayer game of the first player on the basis of an input with the first multiplayer game participation button performed by the second player. At least one of the information processing devices 10 functions as the bonus granting unit 38 for granting a bonus to the second player on the basis of a predetermined condition being satisfied.

Accordingly, since the second player can know that the multiplayer game of the first player is a bonus target via the display of the first multiplayer game participation button, it is possible to increase the motivation of the second player to participate in the multiplayer game of the first player whose predetermined parameter (in this example, rank) is relatively low (in other words, whose proficiency is relatively low), and to encourage the second player to participate in the multiplayer game of the first player whose predetermined parameter (in this example, rank) is relatively low. As a result, the enjoyment of the game as a whole can be improved.

In particular, in this embodiment, the first player is determined to be a relatively beginner player and the second player is determined to be a relatively advanced player on the basis of the difference between the predetermined parameters of the first player and the second player, as one example, rather than the beginner player and the advanced player being divided by an absolute value of the predetermined parameter. Accordingly, a wider range of players can be set as players who request others to participate in a multiplayer game and/or players who participate in a multiplayer game.

More specifically, in a game which has been in operation for a long time, a difference in the proficiency of players for the game appears, and it may be difficult to definitively define a beginner player and/or an advanced player using a predetermined parameter (in this example, rank). For example, a player who has just started the game (herein, also referred to as a beginner), a player who has been playing the game intermittently for several years (herein, also referred to as an intermediate player), and a player who has continuously played the game since the launch of the game (herein, also referred to as an advanced player) have different degrees of proficiency in the game. If the game has been in operation for a long time, there may be a considerable number of intermediate players. These intermediate players can be regarded as beginner players from the viewpoint of players who have continuously played the game since the launch of the game or as advanced players from the viewpoint of players who have just started the game, and there has been a desire for these intermediate players to also send participation requests for multiplayer games and/or to participate in multiplayer games. That is, there has been a desire for more players to engage in participating and having others participate in multiplayer games.

Regarding this, since a multiplayer game is determined to be a bonus target on the basis of the relative difference in a predetermined parameter between the player who sends the participation request and the player who participates in the multiplayer game of the player in response to the participation request, the second player, who is a relatively advanced player, can be encouraged to participate in the multiplayer game of the first player, who is a relatively beginner player. Conversely, the first player, who is a relatively beginner player, can receive help in the multiplayer game from the second player, who is a relatively advanced player. As described above, since more players can participate in multiplayer games both in terms of participating and having others participate, the enjoyment of the game as a whole can be improved.

(2) The predetermined condition of the bonus granting unit 38 includes at least the input with the first multiplayer game participation button 731b performed by the second player. This can prevent bonuses being illicitly obtained. For example, when there is a method of participating in multiplayer games by inputting the ID of the multiplayer game into the battle participation ID input field 81, it is possible to prevent a situation in which one player creates a plurality of accounts, obtains an ID for a multiplayer game with one account, and then inputs the ID with another account to illicitly obtain a bonus.

(3) The predetermined condition of the bonus granting unit 38 includes the number of times a bonus has been granted to the second player per a predetermined amount of time being less than a predetermined number of times. Accordingly, bonuses cannot just be acquired by a limited set of players and many players can receive bonuses. This can make the game as a whole more active (improve the enjoyment of the game as a whole).

(4) The predetermined condition of the bonus granting unit 38 includes the degree of contribution of the second player in the multiplayer game, being a bonus target, of the first player exceeding a predetermined value. This can encourage the second player to proactively assist in multiplayer games which are bonus targets. In addition, by setting a threshold for the degree of contribution, it is possible to make the multiplayer game of the first player a rewarding experience for the second player. For example, by setting the threshold (predetermined value) for the degree of contribution to a high value so that the second player cannot easily be granted the bonus, the enjoyment of the game can be improved, and as a result, the second player can be encouraged to proactively provide assistance.

(5) The multiplayer game execution unit 31 determines, on the basis of the multiplayer game of the first player, the acquired amount of the parameter for increasing the predetermined parameter acquired by the second player, the acquired amount being displayed on the terminal device 10B of the second player. In this manner, by acquiring the acquired amount as a bonus, the predetermined parameter (for example, rank) is increased, which leads the player to becoming an experienced player. Because of this, the second player can be encouraged to proactively assist in multiplayer games which are bonus targets.

(6) The multiplayer game execution unit 31 determines the bonus in accordance with the predetermined parameter of the second player. Accordingly, since the bonus granted may change according to the predetermined parameter of the second player, it is possible to provide an incentive for the second player to participate in the multiplayer game of the first player.

(7) At least one of the information processing devices 10 is caused to function as the participation request reception unit 32 for receiving a participation request for the second player different from the first player to participate in the multiplayer game of the first player. This encourages the second player to participate in the multiplayer game using a participation request from the first player as a trigger. In this embodiment, a participation request from the first player is a condition for the second player participating in the multiplayer game. However, in another embodiment, regardless of whether or not there is a participation request from the first player, the server 10A (for example, the second player determination unit 33 and the participation request transmission control unit 35) may determine the second player and transmit a participation request for the multiplayer game of the first player to the terminal device 10B of the determined second player.

(8) At least one of the information processing devices 10 is caused to function as the second player determination unit 33 for determining a second player with a greater predetermined parameter thereof than the first player and with a difference from the predetermined parameter of the first player that is equal to or greater than the predetermined value, and at least one of the information processing devices 10 is caused to function as the participation request transmission control unit 35 for transmitting a participation request for the multiplayer game, being a bonus target, of the first player to the terminal device 10B of the second player. Then, the second player determination unit 33 determines, from among the plurality of players excluding the first player, a predetermined number or more of the second players with the predetermined parameter thereof being greater than the predetermined parameter of the first player and a difference from the predetermined parameter of the first player being equal to or greater than the predetermined value.

Thus, the participation request can be transmitted to more second players, which increases the probability of the second players participating in the multiplayer game of the first player.

Embodiment Realized by System without Using Network

In the game system 1, the plurality of information processing devices 10 may communicate with each other via a wired or wireless connection without using the network N. In this case, the entirety or a portion of the information processing devices 10 may have the functions of the units 31 to 38. In other words, a portion of the plurality of information processing devices 10 constituting the game system 1 may have the functions of the units 31 to 38 and serve as the server 10A in the above-described embodiment. The functions of the units 31 to 38 may be integrated into one information processing device 10 or may be distributed to a plurality of information processing devices 10.

### Other Embodiments

In another embodiment of the present invention, a program for realizing the functions of the embodiment of the present invention described above and the information processing illustrated in the flowcharts and a computer-readable storage medium storing the program can be provided. In addition, in another embodiment, a method for realizing the functions of the embodiment of the present invention described above and the information processing illustrated in the flowcharts can be provided. In addition, in another embodiment, a server that can supply a computer with the program for realizing the functions of the embodiment of the present invention described above and the information processing illustrated in the flowcharts can be provided. In addition, in another embodiment, a virtual machine that realizes the functions of the embodiment of the present invention described above and the information processing illustrated in the flowcharts can be provided.

In the processing or operations described above, the processing or operations can be modified freely as long as there is no occurrence of contradiction in the processing or operations such as using data that is not yet supposed to be used in a corresponding step. In addition, each example described above is exemplified for describing the present invention, and the present invention is not limited to these examples. The present invention may be implemented in various forms without departing from the scope thereof.

For example, the information processing device 10 according to a modification of the above-described embodiment is the information processing device 10 for a game including a multiplayer game in which a plurality of players participate via a player requesting other players to participate, the information processing device 10 including: the multiplayer game execution unit 31 for executing the multiplayer game on the basis of an operation of a first player; the participation request reception unit 32 for receiving a participation request for a second player different from the first player to participate in a multiplayer game of the first player; the bonus target determination unit 34 for determining whether or not the multiplayer game of the first player is a bonus target multiplayer game on the basis of whether or not the predetermined parameter of the first player is less than a first predetermined value; the display determination unit 36 for determining to display the first multiplayer game participation button associated with the multiplayer game, being the bonus target, of the first player in a manner indicating that the multiplayer game of the first player is the bonus target in a display region of a multiplayer game participation button associated with the second player; the participation determination unit 37 for determining to allow the second player to participate in the multiplayer game of the first player on the basis of an input with the first multiplayer game participation button performed by the second player; and the bonus granting unit 38 for granting a bonus to the second player on the basis of a predetermined condition being satisfied.

Accordingly, since the second player can know that the multiplayer game of the first player is a bonus target via the display of the first multiplayer game participation button 731b, it is possible to increase the motivation of the second player to participate in the multiplayer game of the first player who is a beginner player, and to encourage the second player to participate in the multiplayer game of the first player who is a beginner player. As a result, the enjoyment of the game as a whole can be improved.

Instead of or in addition to the bonus target determination unit 34 “determining that the multiplayer game of the first player is a bonus target when the predetermined parameter of the second player is greater than the predetermined parameter of the first player and the difference between the predetermined parameter of the second player and the predetermined parameter of the first player is equal to or greater than the predetermined value”, the bonus target determination unit 34 may “determine whether or not the multiplayer game of the first player is a bonus target multiplayer game on the basis of whether or not the predetermined parameter of the first player is less than the first predetermined value”. That is, in the above-described embodiment, it is defined that the first player is a relatively beginner player, but in the present modification, a first player with a predetermined parameter (for example, rank) that is less than the first predetermined value is defined as a beginner player. That is, in the present modification, a beginner player is defined using the absolute value of the predetermined parameter as a reference. In this manner, in the above-described embodiment, a beginner player is defined in relativistic terms, and in the present modification, a beginner player is defined in absolute terms. In other words, the present invention can encourage other players to participate in a multiplayer game of a player who is a beginner player regardless of how a beginner player is defined.

The display determination unit 36 may determine to display the first multiplayer game participation button 731b in the display region when the predetermined parameter of the second player is equal to or greater than a second predetermined value. Accordingly, the second player who is an advanced player can be encouraged to participate in the multiplayer game of the first player who is a beginner player. For example, if a player with a rank lower than the first predetermined value (for example, 150) is defined as a beginner player and a player with a rank equal to or higher than the second predetermined value (for example, 100) is defined as an advanced player, the second player can participate in the multiplayer game of the first player even if the second player has a lower rank than the first player.

The display determination unit 36 may determine to display the first multiplayer game participation button 731b in the display region when the predetermined parameter of the second player is equal to or greater than the second predetermined value which is greater than the first predetermined value. Accordingly, the second player who is an advanced player can be encouraged to participate in the multiplayer game of the first player who is a beginner player. In other words, the second player whose rank is always higher than that of the first player can participate in the multiplayer game of the first player. Thus, it is possible to support the first player who is a beginner player.

### REFERENCE SIGNS LIST

1 Game system
10 Information processing device
10A Server
10B Terminal device
11 Processor
12 Input device
13 Output device
14 Storage device
15 Communication device
16 Bus
21 Input unit
22 Output unit
23 Storage unit
24 Communication unit
25 Game control unit
31 Multiplayer game execution unit
32 Participation request reception unit
33 Second player determination unit
34 Bonus target determination unit
35 Participation request transmission control unit
36 Display determination unit
37 Participation request determination unit
38 Bonus granting unit
N Network

1. A non-transitory computer readable medium storing a program for a game including a multiplayer game in which a plurality of players participate, the program causing a computer to function as:
a multiplayer game executor for executing the multiplayer game on the basis of an operation of a first player;
a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
a participation determiner for determining to allow the second player to participate in the multiplayer game of the first player on the basis of an input with the first multiplayer game participation button performed by the second player; and
a bonus granter for granting a bonus to the second player on the basis of a predetermined condition being satisfied.

2. The non-transitory computer readable medium according to claim 1, wherein
the predetermined condition of the bonus granter includes at least the input with the first multiplayer game participation button performed by the second player.

3. The non-transitory computer readable medium according to claim 1, wherein
the predetermined condition of the bonus granter includes the number of times the bonus has been granted to the second player per a predetermined amount of time being less than a predetermined number of times.

4. The non-transitory computer readable medium according to claim 1, wherein
the predetermined condition of the bonus granter includes a degree of contribution of the second player in the multiplayer game, being a bonus target, of the first player exceeding a predetermined value.

5. The non-transitory computer readable medium according to claim 1, wherein
the multiplayer game executor determines, on the basis of the multiplayer game of the first player, an acquired amount of a parameter for increasing the predetermined parameter acquired by the second player, the acquired amount being displayed on a terminal device of the second player.

6. The non-transitory computer readable medium according to claim 1, wherein
the multiplayer game executor determines the bonus in accordance with the predetermined parameter of the second player.

7. The non-transitory computer readable medium according to claim 1, causing the computer to function as:
a participation request receiver for receiving a participation request for the second player different from the first player to participate in the multiplayer game of the first player.

8. The non-transitory computer readable medium according to claim 1, further causing the computer to function as:
a second player determiner for determining the second player with the predetermined parameter thereof being greater than the predetermined parameter of the first player and a difference between the predetermined parameter of the second player and the predetermined parameter of the first player being equal to or greater than a predetermined value; and
a participation request transmission controller for transmitting a participation request for the multiplayer game, being the bonus target, of the first player to a terminal device of the second player, wherein
the second player determiner determines, from among a plurality of players excluding the first player, a predetermined number or more of the second players with the predetermined parameter thereof being greater than the predetermined parameter of the first player and a difference between the predetermined parameter of the second player and the predetermined parameter of the first player being equal to or greater than a predetermined value.

9. The non-transitory computer readable medium according to claim 1, wherein the multiplayer game is a multi-battle game in which a plurality of players battle against a common enemy character.

10. The non-transitory computer readable medium according to claim 1 comprising at least one of following configurations [2] to [9]:
[2] the predetermined condition of the bonus granter includes at least the input with the first multiplayer game participation button performed by the second player;
[3] the predetermined condition of the bonus granter includes the number of times the bonus has been granted to the second player per a predetermined amount of time being less than a predetermined number of times;
[4] the predetermined condition of the bonus granter includes a degree of contribution of the second player in the multiplayer game, being the bonus target, of the first player exceeding a predetermined value;
[5] the multiplayer game executor determines, on the basis of the multiplayer game of the first player, an acquired amount of a parameter for increasing the predetermined parameter acquired by the second player, the acquired amount being displayed on a terminal device of the second player;
[6] the multiplayer game executor determines the bonus in accordance with the predetermined parameter of the second player;
[7] the computer is further caused to function as
a participation request receiver for receiving a participation request for the second player different from the first player to participate in the multiplayer game of the first player;
[8] the computer is further caused to function as
a second player determiner for determining the second player with the predetermined parameter thereof being greater than the predetermined parameter of the first player and a difference between the predetermined parameter of the second player and the predetermined parameter of the first player being equal to or greater than a predetermined value, and
a participation request transmission controller for transmitting a participation request for the multiplayer game, being the bonus target, of the first player to a terminal device of the second player, wherein
the second player determiner determines, from among a plurality of players excluding the first player, a predetermined number or more of the second players with the predetermined parameter thereof being greater than the predetermined parameter of the first player and a difference between the predetermined parameter of the second player and the predetermined parameter of the first player being equal to or greater than a predetermined value; or
[9] the multiplayer game is a multi-battle game in which a plurality of players battle against a common enemy character.

11. An information processing device for executing a game including a multiplayer game in which a plurality of players participate, the information processing device comprising:
a multiplayer game executor for executing the multiplayer game on the basis of an operation of a first player;
a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
a participation determiner for determining to allow the second player to participate in the multiplayer game of the first player on the basis of an input with the first multiplayer game participation button performed by the second player; and
a bonus granter for granting a bonus to the second player on the basis of a predetermined condition being satisfied.

12. A method for a game including a multiplayer game in which a plurality of players participate, the method comprising:
a step of executing the multiplayer game on the basis of an operation of a first player;
a step of determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
a step of determining to display a first multiplayer game participation button associated with the multiplayer game, being the bonus target, of the first player in a manner indicating that the multiplayer game of the first player is the bonus target in a display region of a multiplayer game participation button associated with the second player;
a step of determining to allow the second player to participate in the multiplayer game of the first player on the basis of an input with the first multiplayer game participation button performed by the second player; and
a step of granting a bonus to the second player on the basis of a predetermined condition being satisfied.

13. A system for executing a game including a multiplayer game in which a plurality of players participate, the system comprising:
a plurality of information processing devices, wherein at least one of the plurality of information processing devices functions as a multiplayer game executor for executing the multiplayer game on the basis of an operation of a first player;
at least one of the plurality of information processing devices functions as a bonus target determiner for determining that the multiplayer game of the first player is the bonus target when a predetermined parameter of a second player different from the first player is greater than the predetermined parameter of the first player and a difference between the predetermined parameter of the second player and the predetermined parameter of the first player is equal to or greater than a predetermined value;
at least one of the plurality of information processing devices functions as a display determiner for determining to display a first multiplayer game participation button associated with the multiplayer game, being the bonus target, of the first player in a manner indicating that the multiplayer game of the first player is the bonus target in a display region of a multiplayer game participation button associated with the second player;
at least one of the plurality of information processing devices functions as a participation determiner for determining to allow the second player to participate in the multiplayer game of the first player on the basis of an input with the first multiplayer game participation button performed by the second player; and
at least one of the plurality of information processing devices functions as a bonus granter for granting a bonus to the second player on the basis of a predetermined condition being satisfied.
